(19) United States
(12) Patent Application Publication
(10) Pub. No.: US 2009/0144079 A1
(43) Pub. Date: Jun. 4, 2009

(54) Patient identification mechanism in a telemonitoring system

(76) Inventors: Sultan Haider, Erlangen (DE); Volker Schmidt, Erlangen (DE); Dominic Pascal Schmidt, Erlangen (DE); David Wolfgang Eberhard Schmidt, Erlangen (DE)

Correspondence Address: Siemens Corporation;Intellectual Property Department, 170 Wood Avenue South, Iselin, NJ, 08830, US

(21) Appl. No.: 11/998,388

(22) Filed: Nov. 29, 2007

(51) Int. Cl. G06Q 50/00

(52) U.S. Cl. 705/2

(57) ABSTRACT

A method and a system for obtaining measurement data collected from an object by means of a medical measurement device from a plurality of medical measurement devices. The medical measurement device is personalized by transmitting personalization information to the medical measurement device, the personalization information being related to the object from which the measurement data is to be collected.

A clean copy of the abstract that incorporates the above amendments is provided herewith on a separate page.

### FIELD OF THE INVENTION

The present invention is related to telemedicine and in particular to obtaining medical data from medical measurement devices.

### BACKGROUND OF THE INVENTION

An increasing number of medical facilities like hospitals, clinics or large practices are making ample use these days of electronical medical measurement devices such as electronical blood pressure meters, electronical scales, electrocardiographs (ECG), etc. The electronical medical measurement devices collect biometric data from the patients in digital form. Having the biometric data available in digital form improves workflows within the medical facilities for the purposes of diagnoses and management of patient records considerably. A typical workflow for taking a patient's blood pressure using an electronical blood pressure meter proceeds roughly along the following lines: A doctor decides that the patient's blood pressure must be taken. A specific electronical blood pressure meter having a unique device ID is then applied to the patient and the resulting measurement data is recorded in a suitable digital form, as a single pair of values (systolic/diastolic pressure) or as a series of pairs of values of the patients blood pressure if the patient's blood pressure is to be monitored over a certain time period. The measurement data is then fed into a computer so that a doctor or other medical personal can examine the data within suitable software. At some point during the workflow the measurement data is stored in the patient's record maintained by the medical facility's IT health system. The patient's record is normally updated by the newly acquired measurement data on the basis of the patient's ID and the device ID of the specific medical measurement device used for collecting the measurement data. It frequently happens though, that the patient's record gets wrongly updated by measurement data collected from another patient. This can have severe medical consequences as, for example, a first patient might suffer from a heart condition and yet his patient record gets erroneously updated by measurement data collected from a second patient having no such heart condition. This can easily happen if a specific blood pressure meter that was selected to be applied to the first patient ends up, by mistake, taking the blood pressure for the second patient. Crucial medical diagnostic measures might therefore not be applied to the first patient as the first patient's wrong patient record does not suggest the application of such measures. This mismatching of medical measurement data with a patient's ID happens because there is no intrinsic, robust relationship between the device ID of the medical measurement device selected for collecting the measurement data and the ID of the patient from whom the measurement data is being collected. The mismatch might, for example, be caused by the medical measurement devices being repaired, exchanged or erroneously handed to another patient rather than to the one to which the medical measurement devices was actually assigned to. Conventional methods for establishing a relationship between the medical measurement device ID and the patient's ID proved to be error prone.

There is therefore a need for a method and a system for creating a robust relationship between the medical measurement device used and a patient in order to substantially rule out mismatching the medical measurement data collected from the patient by the medical measurement device measure and the patient's ID.

### SUMMARY OF THE INVENTION

One aspect of the present invention addresses these needs by providing a method and a system for obtaining measurement data collected from an object by means of a medical measurement device from a plurality of medical measurement devices, the method comprising:
personalizing the medical measurement device by transmitting personalization information to the medical measurement device. The personalization information is related to the object from which the measurement data is to be collected;
collecting a measurement data from the object by the personalized medical measurement device; and
obtaining the measurement data from the object by receiving the measurement data in conjunction with a personalization information from the personalized medical measurement device.

According to one aspect of the present invention, the personalizing of the medical measurement device further comprises selecting the medical measurement device by means of which the measurement data is to be collected from the object.

According to one aspect of the present invention, the personalizing of the medical measurement device further comprises retrieving the personalization information from a central object database.

According to one aspect of the present invention, the obtaining the collected measurement data from the object further comprises updating the central object database with the received measurement data by using the personalization information received in conjunction with the received measurement data. The central object database is updated by merging the received measurement data into the central object database.

According to one aspect of the present invention, a central agent transmits the personalization information to the selected medical measurement device. After the selected medical device, which is now considered a personalized medical measurement device, has collected the measurement data from the object, the personalized medical measurement device transmits the collected measurement data in conjunction with the personalization information back to the central agent.

The term “object” is to be construed widely, for example a patient in a medical facility.

The term “medical measurement device” is to include in particular, mobile devices such as electronical blood pressure meter, an electrocardiograph (ECG), a CT scan system (CT) or something as simple as electronical scales. The medical measurement device is thought to be able to express the measurement data in digital form. However, non-medical measurement devices, such as probes or trackers can also be used for the purposes of the invention, in which case the object might be a machine part, a car etc.

By “selecting the medical measurement device” is meant any activity suitable for singling out from a plurality of medical measurement devices a specific medical measurement device that is to collect the measurement data from the object.

By “collecting measurement data from the object” is meant the actual process of interaction between the object and the medical measurement device for the purposes of capturing signals (for example biometric signals such as pressure within the patient's vessels or electrical signals when it comes to the patient's cardiac activity) representative of the data one is interested in.

By “obtaining measurement data” is meant the process or a sequence of steps usually applied to the measurement data after the measurement data has been collected. The process normally comprises steps such as transmitting or sending the data for post-processing or storing/archiving the measurement data in database system.

The term “personalization information” includes, but is not limited to, information uniquely identifying the object from which object the measurement data is to be collected. Examples are a Patient's name in combination with the patient's birth day or a unique Patient ID issued to the patient upon checking-into a medical facility.

By “personalizing” is meant the process of associating the personalizing information uniquely identifying the object with the medical measurement device that is to collect the measurement data from the object. Personalizing the medical measurement device can be done for example by transmitting the personalization information to the medical measurement device or by entering the personalization information manually into the medical measurement device. The medical measurement device is considered to be personalized, once the personalization information has been received by the medical measurement device. Furthermore, a number of medical measurement devices can be personalized simultaneously or in parallel. For example if the patient is to proceed to a CT scan system after his weight has been recorded on an electronical scales, the two medical measurement devices, the CT scan system and the electronical scales, are selected and personalized simultaneously.

According to an alternative aspect of the present invention, two medical measurement devices having been personalized by the same personalization information can exchange the measurement data collected from the same patient. The electronical scales would for example transmit the measurement data in conjunction with the personalization information not only to the central agent but would also forward measurement data in conjunction with the personalization information to the CT scan system, where the measurement data in conjunction with the personalization information is received and used to configure the CT scan system properly on the basis of the value of the weight received. It is contemplated, that only those medical measurement devices that have been personalized by the same personalization information are allowed to exchange measurement data.

By personalizing the medical measurement through transmitting the personalization information, for example a Patient ID, to the medical measurement device that is to collect the measurement data from the patient, a robust relationship between the medical measurement device and the patient's ID is being established. By a robust relationship is meant, that even if the medical measurement device is repaired, exchanged or if the medical measurement device collects the measurement data from a number of patients, erroneously updating a patient's record by measurement data collected from another patient is substantially ruled out.

According to one aspect of the present invention, the measurement data is collected locally, that is the medical measurement device and the object are substantially at he same location. However for the purposes of the invention, the medical measurement device could also be equipped with probes or sensors enabling the medical measurement device to collect the measurement data remotely.

According to one aspect of the present invention, the personalizing of the medical measurement device is executed centrally, for example from a central agent.

According to one aspect of the present invention, the personalizing of the medical measurement device is executed locally at the medical measurement device by manually entering the personalization information into the medical measurement device to be personalized.

According to one aspect of the present invention the measurement data in conjunction with the personalization information is further received by a mobile information processing device from the personalized at least one medical device via a wireless network. The mobile information processing device could be a cell phone, a personal digital assistant (PDA) or a laptop. The personalization information is either transmitted simultaneously to the mobile information processing device and the central agent and the central object database or the personalization information is transmitted to the mobile information processing device before or after the personalization information is or has been transmitted to the central agent and the central object database.

According to one aspect of the present invention, the mobile information processing device is connectable to the central object database for retrieving the measurement data with which the central object database has been updated after the measurement data has been collected from the object by the personalized medical measurement device.

Another aspect of the present invention addresses these needs by providing a computer readable medium having computer-executable instructions for performing a method comprising:
Personalizing a medical measurement device by transmitting personalization information to the medical measurement device. The personalization information is related to an object from which object the measurement data is to be collected;
Collecting the measurement data from the object by the personalized medical measurement device; and
Obtaining the collected measurement data by receiving the collected measurement data in conjunction with the personalization information from the personalized medical device.

A yet another aspect of the present invention addresses these needs by providing a system for obtaining measurement data collected from an object by means of a medical measurement device from a plurality of medical measurement devices connected in a network, the system comprising:
A central agent for providing personalization information for the medical measurement device that has been selected to collect the measurement data from the object and for obtaining the collected measurement data from the selected medical measurement device;
A personalization means interfacing with the central agent. The personalization means is connectable to the medical measurement device via the network and has a network interface for personalizing the selected medical measurement device by transmitting personalization information to the selected medical measurement device. The selected medical measurement device has an interface for receiving the personalization information. The personalization information is related to the object from which object the measurement data is to be collected by the selected medical measurement device;
The personalized medical measurement device is connectable to the central agent via the network. The personalized medical measurement device collects the measurement data from the object and the personalized medical measurement device transmits the measurement data in conjunction with the personalization information to the central agent.

Normally the system comprises a plurality of medical measurement devices and a plurality of objects from which objects the measurement data is to be collected.

According to another aspect of the present invention, the central agent is associated with a central object database, the central object database having the personalization information.

According to one aspect of the present invention, the network is a wireless network and the transmitting of personalization information and the receiving of the personalization information in conjunction with the measurement data being based on the bluetooth protocol. The personalization means and the medical measurement device have bluetooth interfaces.

A yet another aspect of the present invention addresses these needs by providing a Medical measurement device to be used in the system according to the aspect of the invention explained above. The medical measurement device has a bluetooth interface for receiving the personalization information and transmitting the personalization information via the network, and the network is a wireless network using the bluetooth protocol.

### BRIEF DESCRIPTION OF THE DRAWINGS

FIG. 1 is a schematic diagram showing the operation of the components of the system for obtaining measurement data according to one aspect of the present invention.

FIG. 2 is high level flow chart for the method of obtaining measurement data according to one aspect of the present invention.

### DETAILED DESCRIPTION

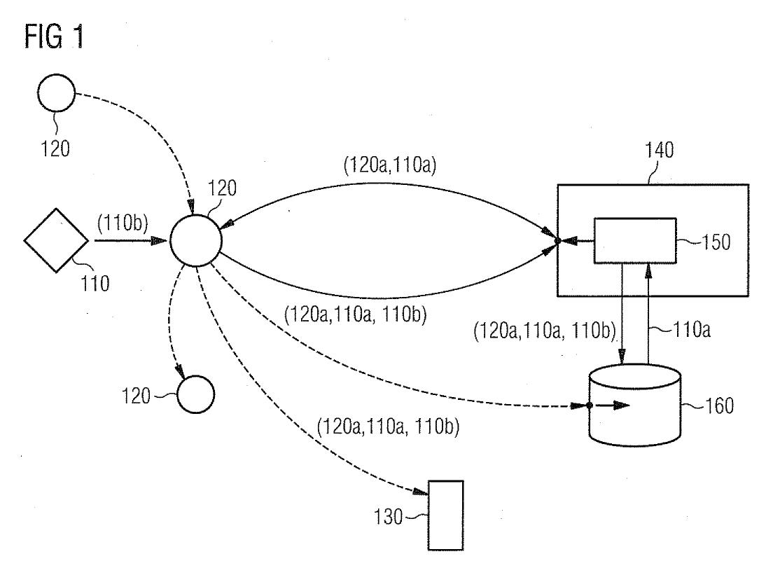

FIG. 1 is a schematic diagram illustrating one aspect of the present invention. A number of medical measurement devices 120 are depicted that are expected to be found in a medical facility for example a blood pressure meter, electronic scales and an ECG. The medical measurement devices 120 are equipped with a bluetooth interface allowing transmission an reception of data via a wireless network to and from other medical measurement devices 120, a mobile information processing device 130 (for example a cell phone, a PDA, etc.) or a central object database 160 and/or a central agent 140.

According to one aspect of the present invention the medical measurement devices 120 are shown to be connected in a wireless network. This is for the purposes of convenience for the patients, as the wireless network would allow an object 110, for example the patient, to freely move around on the premises of the medical facility whilst his or her blood pressure is being taken by an electronic blood pressure meter 120. The blood pressure meter is taken to be representative of other medical measurement devices 120 for the purposes of explanation. Other wireless protocols such as WiFi or UMTS might also be advantageously used for the purposes of the invention. In order to overcome the limited range when using bluetooth interfaces (the range depends on the bluetooth interface being class 1, 2 or 3), a number of relay stations are provided and suitably distributed across the premises of the medical facility. The transmitted data are then picked up by the relay stations and relayed by connecting to a LAN of the medical facility to the central agent 140, the central object database 160, to other medical measurement devices 120 or to the mobile information processing device 130.

If the object 110 is thought to the stationary, the use of more conventional hardwired network can also be contemplated.

For ease of explanation the operation of the system according to the invention as depicted in FIG. 1 the object 110 will be taken to be the patient and the medical measurement device 120 shall be taken to be an electronic blood pressure meter equipped with a bluetooth interface. This shall not be construed as limiting the scope of the invention as other applications from different fields can also be contemplated.

After it has been decided that the blood pressure from patient 110 needs to be taken an operator at the central agent 140 retrieves personalization information 110a, for example in form of the patient's ID, from a central patient database 160. The central agent 140 is a desktop computer or a mobile computer connectable for example via the medical facilities LAN to the central patient database 160 as maintained by the general IT-health system of the medical facility. The central patient database 160 could be for example a rational database management system RDBMS in which the patient's' 110 record is arranged as rows in tables, the rows having fields with different entries such as the patient ID 110, the name of the patient, the birthday of the patient, place of residence, etc. This information or a selection thereof, uniquely identifying the patient 110 is comprised by personalization information 110a.

As an example, the patient's ID shall be taken to constitute parts of the personalization information 110a. After the central agent 140 has retrieved the patient's ID from the central patient database 160 on the basis of the patient's 110 name for example, the patient's ID is fed into a personalization means 150. The personalization means 150 is a software or hardware module controlling for example a graphical display showing a number of electronic blood pressure meters 120 available in the medical facility, preferably arranged according to the various departments and wards in which they are to be found.

According to one aspect of the present invention, those blood pressure meters 120 currently in use are flagged down as busy, allowing the operator to make a suitable selection from vacant electronic blood pressure meters 120. The selection can be effected for example by clicking with a mouse on an icon displayed on the graphical display and being representative for the electronic blood pressure meter 120 that the operator wishes to use for taking the patient's 110 blood pressure. The personalization means 150 compiles the personalization information 110a by combining the device ID 120a of the selected electronic blood pressures device 120 and the patient's ID. The personalization information 110a is a message expressed in a suitable format for example in XML or according to the HL-7 protocol. However, any other format can be used for the purposes of the invention. If the personalization information 110a is to be expressed in XML the personalization means 150 has translation module arranged before or within the central agent's 140 bluetooth interface. The translation module translates the device ID 120a of the selected blood pressure meter 120 and the patient's ID within the personalization information 110a into an XML expression. The patient's ID and the device ID 120a are assigned in the usual manner to attribute values of suitably named XML-elements. The personalization information 110a in the form of a XML-message are then transmitted by having the central agent's 140 bluetooth interface pass the personalization information 110a XML-message to the electronic blood pressure meter 120 having the corresponding device ID 120a as embedded in the XML-message. Upon reception of the XML-message by the bluetooth interface of the corresponding electronic blood pressure meter 120 the XML-message is being stored in a storage module, the storage module being arranged for example in the bluetooth interface of the electronic blood pressure meter 120. The electronic blood pressure device 120 is now considered to be personalized by the personalization information 110a embedded within the XML-message. Upon reception of the XML-message at the personalized electronic blood pressure device 120, a corresponding confirmation message is transmitted from the personalized electronic blood pressure device 120 back to the central agent 140. The central agent 140 then flags the personalized electronic blood pressure meter 120 as “busy”. It is now ruled out that another personalization information related to another patient be transmitted to the personalized electronic blood pressure meter 120. The patient 110 can then proceed in the personalized electronic blood pressure meter 120 and have its blood pressure taken. The electronic blood pressure meter 120 collects the measurement data 110b as a pair of numbers indicating the systolic and diastolic pressure respectively. The details of the inner operation of the electronic blood pressure meter 120 are not relevant for the purposes of the invention. Usually the signal path proceeds from the biometric data such as pressure values picked up by signal specific transducers to a bio amplifier, a band pass filter and a micro controller. The microcontroller converts the signal into digital a signal and a codec module then translates the digital signal into a string either for display on a graphics display arranged at the electronic blood pressure meter 120 of to have the string ready for transmission back to the central agent 140 and/or the central patient database 160.

A translation module within the electronic blood pressure meter 120 translates collected measurement data 110b into another XML-message by appending the XML-element having the measurement data 110b as a new attribute value to the previous XML-message currently residing within the storage module of the electronic blood pressure meter 120. The new personalization information 110a is now stored as an XML-message within the storage module of the electronic blood pressure device 120 comprises least three XML elements, each having as attribute values the device ID 120a of the electronic blood pressure meter 120, the patient's ID, and the just appended measurement data 110b. The electronic blood pressure meter 120 then either transmits this new XML-message to the central agent 140 or to the central patient database 160 or waits for further measurement data to be collected. The later option is useful in case the patient must for example have his blood pressure taken or a prescribed period of time. In this case the XML-message would be constantly updated by having further pairs of systolic and diastolic values appended to the XML-message. When exactly the electronic blood pressure meter 120 transmits the new XML-message encoding the personalization information 110a and the measurement data 110b collected at the patient 110 depends on other parameters thought to be present in the new XML-message. A further XML-element, for example, might have an attribute value indicating the number of measurement data that needs to be collected before the new XML-message will be transmitted back to the central patient database 160.

Upon reception of the new XML-message at the central patient database 160 or at the central agent 140 an XML parser is employed in order to parse the new XML-message for each of XML-elements into the respective attribute values, such as to extract the personalization information 110a, that is the patient's ID and the device ID 120a, and the collected measurement data 110b. The central patient database 160 then uses the patient's ID from the personalization information 110a as a key in order to find a row, within one of the tables, the table corresponding to the patient having the patient ID from the personalization information 110a. The patient's record is then updated by using standard database operations such as merging the measurement data 110b and device ID 120a into the row, found. Merging the device ID 120a into the patient's record along with the measurement data 110b is a further security measure in order to rule out other inconsistencies. For example the central patient database 160 might also hold a table listing a number of device IDs 120a along with a description of a format of the corresponding measurement data 110b when collected by the medical measurement 120 having those listed IDs 120a. For example if the device ID 120a is indicative to a blood pressure meter 120 then the format of the measurement data 110b is expected to be a pair of numbers. If on the other hand a triple of numbers is detected upon a reception and parsing of the new XML-message, an incompatibility warning is being issued, in order to indicate that an error must have been occurred somewhere in the process of obtaining the measurement data 110b.

According to another aspect of the present invention the personalization information 110a and the measurement data 110b is not only transmitted to the central agent 140 and/or the central database 160, but also to the mobile information processing device 130 such as a PDA or a cell phone of the doctor who is overseeing the treatment of the patient 110. In this way the doctor can easily monitor the measurement data 110b collected from the patient 110a, enabling the doctor to react much faster in case the collected measurement data 110b shows some life threatening condition of the patient 110. A situation like this can be easily pictured by taking the measurement data 110b to be a cardiac frequency.

According to yet another aspect of the present invention the medical measurement device 120 is interfacing with other medical measurement devices 120 such as to transmit the measurement data 110b collected at one of the medical measurement devices 120 to another medical measurement device 120 or to other medical devices. The measurement data 110b is for example needed in order to adjust certain parameters at the other medical measurement device 120 receiving the measurement data 110b. For example one medical measurement device 120 might be an electronic scale, on which the weight of a patient is detected and upon detection is transmitted to a CT scan system, where the patient is to be treated subsequently. The patient's weight is here a parameter that is needed at the CT scan system for configuration purposes before commencing a CT scan session at the CT scan system.

According to yet another aspect of the present invention it is contemplated that the medical measurement devices 120 can be personalized locally by having medical personal feeding the personalization information 110a directly into the corresponding medical measurement device 120 that is to be used for collecting the measurement data 110b from the patient 110. According to this aspect of the present invention the medical measurement device 120 is equipped with, for example, a barcode reader by means of which personalization information 110 can be entered into the medical measurement device 120 to be personalized. Medical personnel for example can use the central agent 140 or another computer system arranged with a printer suitable to connect to the central patient database 160 in order to retrieve the patient's ID for the personalization information 110a. The personalization information 110b is then printed out with the printer to obtain a barcode on a suitable sheet of paper. This barcode is then taken by the medical personnel any vacant medical measurement device 120 and used to personalize the medical measurement device 120 on the spot.

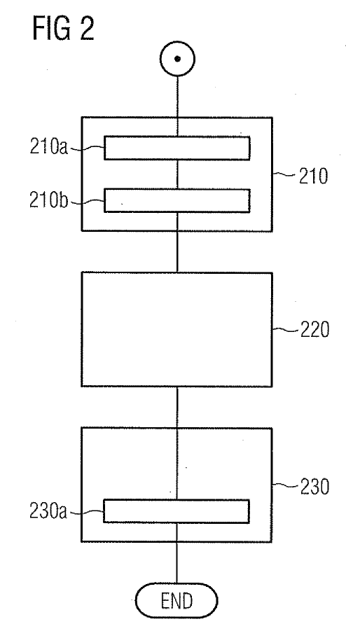

FIG. 2 shows a flow chart illustrating one aspect of a method according to the present invention for obtaining measurement data 110b collected from the object 110 by means of a medical measurement device 120.

In step 210 the medical measurement device 120 is personalized by transmitting the personalization information 110a to the medical measurement device 120 that is to collect the measurement data 110b from the object 110 after the medical measurement device 120 has been selected in step 210a by the central agent 140 and after the personalization information 110a has been retrieved in step 210b from the central object database 160.

In step 220 the measurement data 110b is collected from the object 110 by the now personalized medical measurement device 120.

In step 230 the collected medical measurement data 110 is obtained by having the central object database 160 and/or the central agent 140 receive the collected measurement data 110b in conjunction with the personalization information 110a from the personalized medical device 120.

The central object database 160 is then updated in step 230a by receiving the measurement data either directly from the personalized medical measurement device 120 or via the central agent. The updating uses the personalization information 110a received in conjunction with the received measurement data 110b for merging the received measurement data 110b into the central object database 160.

It is to be understood that the above description is intended to be illustrative, and not restrictive. Many other embodiments will be apparent to those of skill in the art upon reviewing the above description. For instance, it is clear, that the method according to the present invention as described above in FIG. 2 could also be used in a completely different setting.

The scope of the invention should, therefore, be determined with reference to the appended claims, along with the full scope of equivalents to which such claims are entitled.

1.-14. (canceled)

15. A method for obtaining measurement data collected from an object by a medical measurement device, comprising:
personalizing the medical measurement device by transmitting personalization information of the object to the medical measurement device;
collecting the measurement data from the object by the personalized medical measurement device; and
obtaining the collected measurement data by receiving the collected measurement data in conjunction with the personalization information from the personalized medical device.

16. The method as claimed in claim 15, wherein the step of personalizing the medical measurement device comprises selecting the medical measurement device from a plurality of medical measurement devices by the measurement data to be collected from the object.

17. The method as claimed in claim 15, wherein the step of personalizing the medical measurement device comprises retrieving the personalization information from a central object database.

18. The method as claimed in claim 15, wherein the step of obtaining the collected measurement data comprises updating a central object database with the received measurement data using the personalization information for merging the received measurement data into the central object database.

19. The method as claimed in claim 15, wherein the measurement data is collected locally.

20. The method as claimed in claim 15, wherein the medical measurement device is personalized centrally.

21. The method as claimed in claim 15, wherein the medical measurement device is personalized locally by manually entering the personalization information into the medical measurement device.

22. The method as claimed in claim 15, wherein the measurement data in conjunction with the personalization information is further received by a mobile information processing device from the personalized medical device via a wireless network.

23. The method as claimed in claim 22, wherein the mobile information processing device is connectable to a central object database.

24. A system for obtaining measurement data collected from an object by a medical measurement device from a plurality of medical measurement devices connected in a network, comprising:
a central agent that provides personalization information of the object for the medical measurement device being selected to collect the measurement data from the object and obtains the collected measurement data from the object by the medical measurement device; and
a personalization unit interfacing with the central agent and being connectable to the medical measurement device via the network that personalizes the medical measurement device by transmitting the personalization information to the medical measurement device, wherein the personalized medical measurement device is connectable to the central agent via the network and transmits the collected measurement data in conjunction with the personalization information to the central agent.

25. The system as claimed in claim 24, wherein the central agent comprises a central object database.

26. The system as claimed in claim 24, wherein the network is a wireless network and the personalization information in conjunction with the collected measurement data is transmitted and received based on bluetooth protocol.

27. A medical measurement device for connecting to a medical system via a network, comprising:
a measurement unit that collects a measurement data from an object;
an interface that receives a personalization information of the object from the system and transmits the collected measurement data in conjunction with the personalization information to the system via the network.

28. The medical measurement device as claimed in claim 27, wherein the network is a wireless network using bluetooth protocol.
